(19) United States
(12) Patent Application Publication
(10) Pub. No.: US 2007/0176843 A1
(43) Pub. Date: Aug. 2, 2007

(54) RF communication system with embedded antenna

(75) Inventors: Khurshid Qureshi, Colorado Springs, CO (US); Scott Gruber, Colorado Springs, CO (US)

Correspondence Address: KUTAK ROCK, LLP, 1801 CALIFORNIA STREET, SUITE 3100, DENVER, CO, 80202-2626, US

(73) Assignee: ZeeWaves Systems, Inc.

(21) Appl. No.: 11/340,875

(22) Filed: Jan. 27, 2006

(51) Int. Cl. H01Q 1/40; H01Q 1/24

(52) U.S. Cl. 343/873; 343/702; 343/700 MS

(57) ABSTRACT

Provided is a wireless RF communications system for use in electronic devices requiring a communication capability. The system, which may be positioned between any two surfaces or panels of the electronic device includes a printed circuit board (“PCB”), a radio module incorporated into the PCB, and at least one antenna embedded in the PCB. A microstrip transmission line interconnects the antenna and radio module. In at least one embodiment, the PCB is flexible. Reduced cost and enhanced performance are recognized through a synergistic manufacturing process wherein components are etched or otherwise placed in sequence or concurrently onto a single PCB, and interconnect cables are eliminated.

This non-provisional application claims priority to provisional application Serial No. TBD, entitled “Embedded Radio with Antenna” filed TBD and incorporated herein by reference.

### FIELD OF THE INVENTION

This invention relates generally to electronic devices requiring radio frequency (“RF”) communication capabilities, such as notebook or laptop computers, cell phones, personal digital assistants (“PDAs”), etc. More particularly, to a wireless RF system with one or more embedded antennas integrated between a front and a back surface or panel of the electronic device.

### BACKGROUND

RF communication systems for portable electronic devices, such as laptop computers, cell phones, etc., have often prioritized device integration and packaging over RF performance and component costs. For example, in many notebook or laptop computers, the radio component of an RF communication system is located in the base of the computer, while the antenna is positioned in the computer cover in close proximity to the display panel. This configuration requires an RF cable or coax cable to interconnect the antenna with the radio module. The RF cable must, quite obviously, be routed between the base and cover section. As a result, significant RF losses may occur during the receipt and transmission of RF signals through the coax cable.

A further disadvantage noted with existing systems is the inability to integrate multiple antennas, operating over multiple frequency bands, into a single, compact communication device. Dual band, tri-band, and multi-band systems currently require multiple antennas remotely positioned with respect to the radio module.

In addition to performance degradation, the manufacturing and integration processes of many existing systems are not optimized to minimize complexity and costs. Specifically, component costs are increased by virtue of having separate and distinct manufacturing processes for the antennas, radio module, interconnects, etc. In addition to higher than necessary labor and material costs, this approach to manufacturing increases the cost and time required for integration of the RF system into the electronic device.

Hence there is a need for a wireless RF communication system to overcome one or more of the limitations disclosed above.

### SUMMARY

The embedded antenna system herein disclosed advances the art and overcomes problems articulated above by providing a RF communication system having an antenna and radio module integrated into a single printed circuit board (“PCB”).

In particular, and by way of example only, according to an embodiment, provided is an RF communication system including: a printed circuit board; a radio module incorporated into the printed circuit board; and at least one antenna embedded into the PCB and interconnected with the radio module; wherein the PCB, radio module and antenna are positioned between a front and a back surface of an electronic device.

In another embodiment, provided is an improved wireless RF communication system of the type in which a radio is embedded between a front and a back surface of an electronic device, the improvement including: a PCB; a radio module incorporated into the PCB; at least one antenna embedded into the PCB and interconnected to the radio module; and a microstrip transmission line integrated into the PCB to interconnect the antenna and the radio module.

In yet another embodiment, provided is a method of manufacturing an RF communication system for an electronic device, including: incorporating a radio module into a PCB; embedding at least one antenna into the PCB; interconnecting the antenna with the radio module; positioning the PCB, radio module, and antenna between a front and a back surface of the electronic device.

In still another embodiment, provided is a wireless RF communication device, comprising: a transmit/receive means for receiving and transmitting RF signals; an RF processing means, interconnected to the transmit/receive means, for processing the RF signals; and an interconnecting means for interconnecting the transmit/receive means and processing means, wherein the transmit/receive means and processing means are integrated into a single PCB positioned between a front and a back surface of an electronic device.

### BRIEF DESCRIPTION OF THE DRAWINGS

FIG. 1 is a perspective view of a wireless RF communication system positioned within a laptop computer, according to an embodiment;

FIG. 2 is a plan view of a wireless RF communication system, according to an embodiment;

FIG. 3 is partially cut-away view of a wireless RF communication system positioned within a PDA, according to an embodiment;

FIG. 4 is a front view of the PDA of FIG. 3, according to an embodiment;

FIG. 5 is a plan view of a flexible printed circuit board with an embedded antenna and a radio module; and

FIG. 6 is a flow chart of a manufacturing process, according to an embodiment.

### DETAILED DESCRIPTION

Before proceeding with the detailed description, it should be noted that the present teaching is by way of example, not by limitation. The concepts herein are not limited to use or application with one specific type of wireless RF communication system or RF system with embedded antenna. Thus, although the instrumentalities described herein are for the convenience of explanation, shown and described with respect to exemplary embodiments, the principles herein may be equally applied in other types of wireless RF systems with embedded antenna.

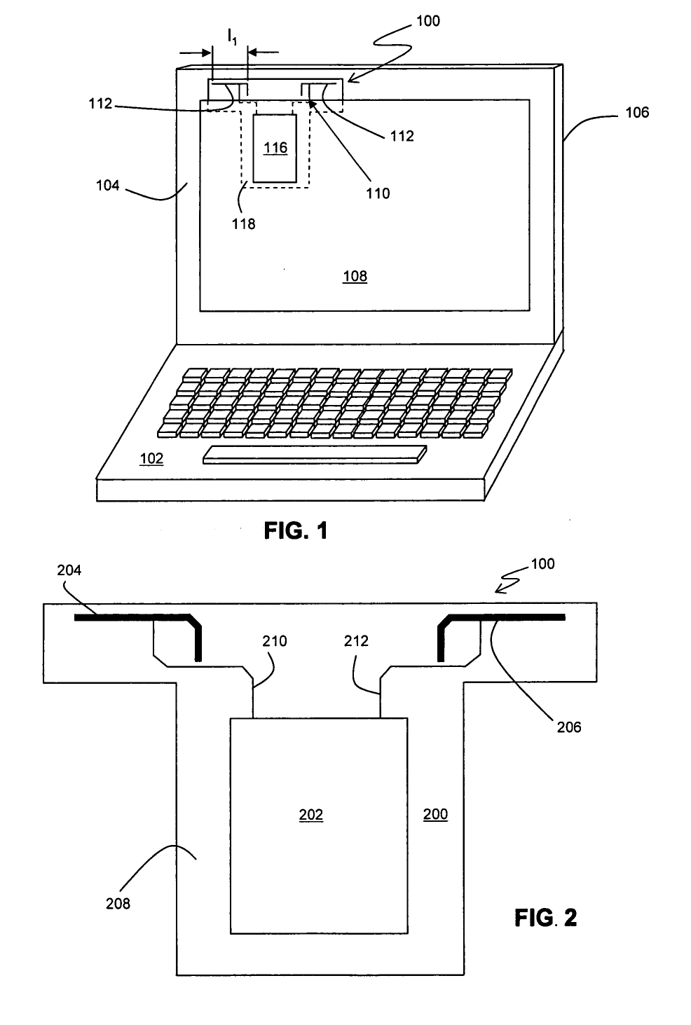

Disclosed is a wireless radio frequency (“RF”) system or communication system having one or more embedded antennas, and a method of manufacturing the same. As illustrated in FIG. 1, in one embodiment the wireless RF system 100 may be integrated into a notebook or laptop computer 102 to function as the RF communication device/link for the computer 102. It can be appreciated, however, that wireless RF system 100 may be positioned within any device having a front surface, wall or panel 104 and a back surface, wall or panel 106, or other structure for encapsulating the wireless RF system 100 within the electronic device. Other devices may include, but are not limited to: computers, cell phones, cell phone towers, personal digital assistants (“PDAs”), personal information devices, access points, base stations, sensing devices (e.g. water sensors), portable devices, as well as others.

Still referring to FIG. 1, wireless RF system 100 may be positioned or encapsulated directly behind front panel 104. Further, wireless RF system 100 may be partially or wholly positioned behind a front panel display, such as display 108 in FIG. 1. As shown, in at least one embodiment wireless RF system 100 is positioned such that the elements of an antenna 110, of which antenna elements 112 and 114 are exemplary, are located above or out from behind display panel 108. Further, each antenna 110 or antenna element 112, 114 will have a defined length “l₁”. In this manner, the transmission and receipt of RF signals, to and from computer 102, is maximized and optimized. By comparison, a radio module 116 and most of a printed circuit board 118 are located behind display panel 108.

Cross-referencing for a moment FIGS. 1 and 2, the specific details of wireless RF system 100 are further disclosed. As disclosed above, wireless RF system 100 includes a printed circuit board or “PCB” 200. PCB 200 may have a rigid or semi-rigid construction, or in at least one embodiment PCB 200 is a flexible or semi-flexible PCB 200. The size and shape of PCB 200 may be specific to the particular design, size and shape of the remaining RF and/or electrical components included in wireless RF system 100, as well as the size and shape of the electronic device.

A radio module 202, of a type well known within the art, is positioned on and/or embedded within PCB 200. In particular, radio module 202 may include components and circuitry surface mounted onto PCB 200 or etched into the circuit board, or combinations thereof. Radio module 202 may be any of a type intended to process RF signals received and/or transmitted by an electronic device having communications capabilities.

In addition to PCB 200 and radio module 202, wireless RF system 100 includes one or more antennas integrated into the system 100, of which antennas 204 and 206 are exemplary. Wireless RF system 100 may include a plurality of antennas, and may include one or more antennas having multiple antenna elements. Antennas 204 and 206 may be mounted to an external surface 208 of PCB 200, or alternatively the antennas 204, 206 may be etched into PCB 200. The antennas 204, 206 may be etched directly onto or into PCB 200 using etch common to radio module 202. In at least one embodiment, antennas 204 and 206 are deposited onto the surface 208 of PCB 200, using vapor or other metal deposition techniques. In yet another embodiment, sputtering is used. In each instance, however, antennas 204 and 206 are integrated with, and integral to, the PCB 200.

Interconnecting radio module 202 to antennas 204 and 206 are microstrip transmission lines 210 and 212 respectively. Microstrip transmission lines 210 and 212 may be etched into PCB 200 and may be manufactured using materials and techniques well known in the art for the manufacture of trace lines or electronic interconnects for PCBs. Received RF signals are transmitted from antennas 204 and 206, along transmission lines 210 and 212, to radio module 202. Similarly, outgoing RF signals are transmitted along lines 210 and 212, from radio module 202 to the antennas 204, 206 prior to transmission.

Antennas 204 and 206 may be tuned for their environment, which is to say tuned to the specific electronic device or specific model of electronic device in which the antennas 204, 206 are positioned (e.g. computer, cell phone, PDA). Further, antennas 204 and 206 may be tuned to match the microstrip transmission line (i.e. lines 210 and 212 respectively) interconnecting each antenna to the RF section (not shown) of radio module 202.

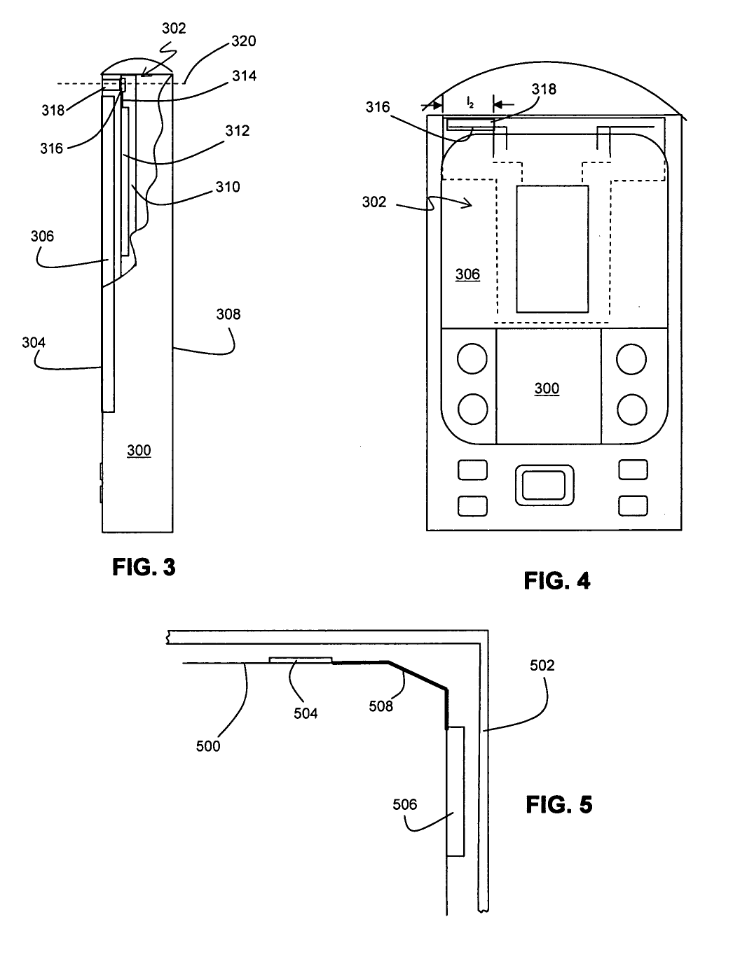

Considering now FIG. 3, a PDA 300 having a partially cut-away section is presented. It can be appreciated that the following discussion, while specific to the PDA of FIG. 3, applies equally to any electronic device having a front wall or surface, a back wall or surface and a wireless RF communication capability. As shown in FIG. 3, a wireless RF system 302 is positioned within the body of PDA 300. More specifically, system 302 is secured behind a front wall or surface 304, a portion of which may include a display screen 306. System 302 is encapsulated between front surface 304 and a rear surface or wall 308.

As discussed in detail above, wireless RF system 302 includes: a PCB 310, a radio module 312 integrated into the PCB 310 by etching or other well known techniques, a microstrip transmission line 314 (which may also be etched) interconnecting radio module 312 and an antenna 316. The circuitry and components (e.g. a processor) for interfacing wireless RF system 302 with the remaining elements of PDA 300 have been omitted for simplicity and clarity of understanding.

Also shown in FIG. 3 is an aperture 318 positioned substantially over or aligned with antenna 316. In at least one embodiment aperture 318 extends laterally, along an axis 320, from front surface 304 to antenna 316, thereby exposing antenna 316, from an electrical and perhaps physical perspective, to the environment outside PDA 300. Aperture 318 may also extend in a direction parallel to antenna 316, and perpendicular to axis 320, for substantially the entire length of antenna 316, as may be seen by cross-referencing FIGS. 3 and 4.

With the inclusion of aperture 318 in wireless RF system 302, antenna 316 is not covered, blocked, partially obscured or otherwise electrically degraded by the material of front surface 304. It can be appreciated that the exposure of antenna 316 helps to ensure maximum efficiency in the receipt and transmission of RF signals when all or part of the front surface 304 is metallic. Even though the use of a plastic or other non-conductive material for front surface 304, to include those areas behind which is positioned antenna 316, may not significantly degrade the performance of antenna 316, aperture 318 may still be included to help ensure the desired RF characteristics are achieved.

In one embodiment, aperture 318 is covered with a plastic pane or “window” (not shown) which is electrically transparent. The pane or window may extend partially into the aperture 318, or may substantially fill the aperture completely. Regardless, the pane is structured and arranged such that the plastic material does not come into direct physical contact with antenna 316.

In FIG. 4, a front view of PDA 300 is presented. Similar to other devices having a display panel 306 on or near a front surface, wireless RF communication system 302 is positioned such that at least some portion of the antenna or antenna elements, e.g. antenna 316, is extended from behind the display screen 306. As noted above, aperture 318 extends for substantially the length “l₂” of antenna 316.

Referring now to FIG. 5, a flexible PCB 500 is presented. As shown, PCB 500 may be flexed or otherwise shaped to substantially conform to the shape of one or more walls or surfaces of the electronic device of interest, of which wall 502 is exemplary. In one embodiment, this wall 502 is the front wall. PCB 500 may be flexible to the extent that physical constraints (bonding, mechanical fasteners, etc.) are needed to shape and secure the PCB 500 in place. Alternatively, PCB 500 may be semi-flexible or “shape retaining” such that the PCB 500 maintains a given shape induced during the manufacturing and assembly process. In this instance, physical constraints well known in the art may still be required to position and secure the PCB 500 within the device.

In at least one embodiment, as shown in FIG. 5, antenna 504 may be located such that the antenna 504 is oriented substantially perpendicular to the front wall 502. In yet another embodiment not shown, antenna 504 may be positioned substantially parallel to this wall 502. The location of radio module 506 is relative to antenna 504, and module 506 may be oriented in substantially the same plane and direction as antenna 504. Alternatively, as shown in FIG. 4, radio module 506 may be positioned and oriented substantially normal to antenna 504. A microstrip transmission line 508 still is used to interconnect radio module 506 and antenna 504.

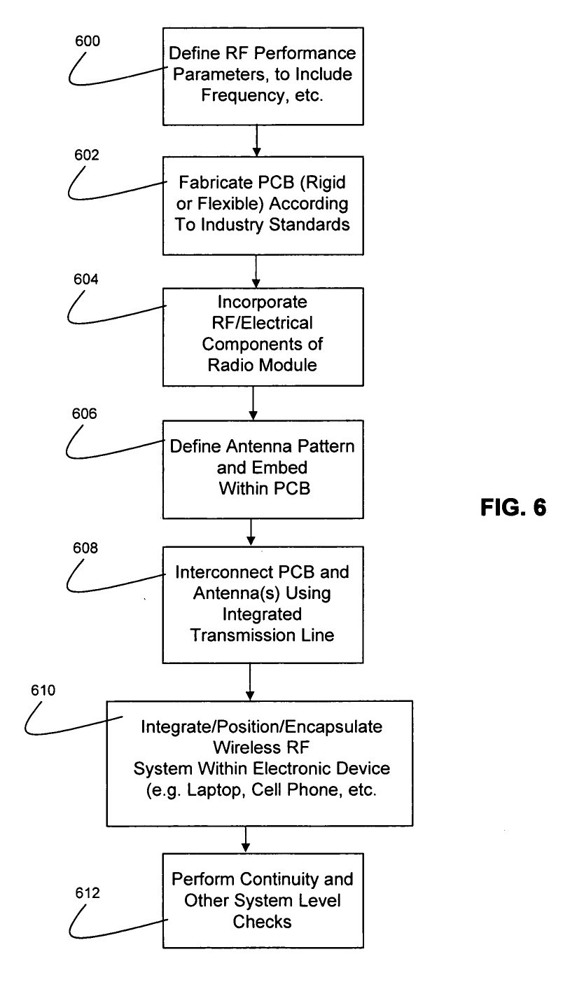

In FIG. 6, a simplified manufacturing process for a wireless RF communication system of the present disclosure is provided. In an initial step, block 600, the RF performance requirements of the wireless RF system should be defined. In many, but not all, instances these requirements or parameters are specific to the electronic device requiring RF communication capabilities. Once requirements are adequately understood, manufacturing begins with the fabrication of the PCB (flexible or otherwise) using techniques well known in the art, block 602.

The sequence of events with regard to the integration of RF components, antennas/antenna elements, etc. may vary depending on the particular details of the wireless RF system and corresponding electronic device. Nonetheless, the RF and electrical components of the radio module are, at the necessary point in time, incorporated with the PCB (block 604) using etching, surface mounting, or other well known techniques. Likewise, the antenna pattern is defined and the antenna(s) are embedded into the PCB (block 606) using any number of techniques which may include etching, vapor deposition, etc. Also, the radio module and antenna are interconnected using a microstrip transmission line, block 608. As with the radio module and antenna, the transmission line or lines may be etched or otherwise integrated with the PCB.

Blocks 600 through 608 of FIG. 5 represent a simplified process for manufacturing a wireless RF system or communication system having an embedded antenna interconnected with an embedded or otherwise integrated radio module. Once the system itself is manufactured, it can be integrated into the electronic device, be that a laptop, cell phone, etc., block 610. As part of that integration process, the wireless RF system itself, and its interoperability with the chosen electronic device, are verified through continuity and other functional checks, block 612.

Significant benefits can be recognized through the use of the manufacturing process described above, and the corresponding wireless RF communication system. Component and system costs are reduced as process steps are combined and optimized, and components such as interconnects and cables are eliminated. The elimination of RF cables also serves to improve RF performance by reducing or minimizing system losses.

Changes may be made in the above methods, devices and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, device and structure.

What is claimed is:

1. An RF communication system comprising:
a printed circuit board (“PCB”);
a radio module incorporated into the printed circuit board; and
at least one antenna embedded into the PCB and interconnected with the radio module;
wherein the PCB, radio module and antenna are positioned between a front and a back surface of an electronic device.

2. The communication system of claim 1, further comprising a microstrip transmission line integrated into the PCB to interconnect the antenna and the radio module.

3. The communication system of claim 2, wherein the at least one antenna is tuned to the specific operating frequency of the electronic device and the microstrip transmission line.

4. The communication system of claim 2, wherein the microstrip transmission line is etched into the PCB.

5. The communication system of claim 1, wherein the radio module is etched into the PCB.

6. The communication system of claim 1, wherein the antenna is embedded into the PCB using a manufacturing technique selected from the group consisting of: etching, deposition, vapor deposition, metal deposition, sputtering and surface mounting.

7. The communication system of claim 1, wherein the system is wireless.

8. The communication system of claim 1, wherein the electronic device is portable.

9. The communication system of claim 1, wherein the electronic device is selected from a group consisting of: a computer, a laptop computer, a personal digital assistant; a personal information device; an access point; and a cell phone.

10. The communication system of claim 1, wherein the PCB is flexible.

11. The communication system of claim 1, wherein a plurality of antennas are etched into the PCB using multiple inputs/multiple outputs logic.

12. An improved wireless RF communication system of the type in which a radio is embedded between a front and a back surface of an electronic device, the improvement comprising:
a printed circuit board (“PCB”);
a radio module incorporated into the PCB;
at least one antenna embedded into the PCB and interconnected to the radio module; and
a microstrip transmission line integrated into the PCB to interconnect the antenna and the radio module.

13. The improved wireless RF communication system of claim 12, wherein the PCB is flexible.

14. The improved wireless RF communication system of claim 12, wherein the electronic device is portable.

15. The improved wireless RF communication system of claim 12, wherein the device is selected from a group consisting of: a computer, a laptop computer, a personal digital assistant; a personal information device; an access point; base station; and a cell phone.

16. A method of manufacturing an RF communication system for an electronic device, comprising:
incorporating a radio module into a printed circuit board (“PCB”);
embedding at least one antenna into the PCB;
interconnecting the antenna with the radio module;
positioning the PCB, radio module, and antenna between a front and a back surface of the electronic device.

17. The method of claim 16, wherein interconnecting includes integrating a microstrip transmission line into the PCB to interconnect the antenna and the radio module.

18. The method of claim 16, wherein embedding further comprises etching the antenna into the PCB.

19. The method of claim 16, wherein the PCB is flexible.

20. A wireless RF communication device, comprising:
a transmit/receive means for receiving and transmitting RF signals;
an RF processing means, interconnected to the transmit/receive means, for processing the RF signals; and
an interconnecting means for interconnecting the transmit/receive means and processing means,
wherein the transmit/receive means and processing means are integrated into a single printed circuit board (“PCB”) positioned between a front and a back surface of an electronic device.

21. The wireless RF communication device of claim 20, wherein the transmit/receive means comprises a plurality of antennas, each antenna operating over a predetermined frequency band.
